(19) United States
(12) Patent Application Publication
(10) Pub. No.: US 2009/0019266 A1
(43) Pub. Date: Jan. 15, 2009

(54) INFORMATION PROCESSING APPARATUS AND INFORMATION PROCESSING SYSTEM

(75) Inventor: Seiji MAEDA, Kanagawa (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 12/037,357

(22) Filed: Feb. 26, 2008

(30) Foreign Application Priority Data
Jul. 11, 2007 (JP) 2007-182619

(51) Int. Cl. G06F 12/08; G06F 9/44

(52) U.S. Cl. 712/220; 711/131; 711/E12.023; 712/E09.028

(57) ABSTRACT

With respect to memory access instructions contained in an internal representation program, an information processing apparatus generates a load cache instruction, a cache hit judgment instruction, and a cache miss instruction that is executed in correspondence with a result of a judgment process performed according to the cache hit judgment instruction. In a case where the internal representation program contains a plurality of memory access instructions having a possibility of causing accesses to mutually the same cache line in a cache memory, the information processing apparatus generates a combine instruction instructing that judgment results of the judgment processes that are performed according to the cache hit judgment instruction should be combined into one judgment result. The information processing apparatus outputs an output program that contains these instructions that have been generated.

### CROSS-REFERENCE TO RELATED APPLICATIONS

This application is based upon and claims the benefit of priority from the prior Japanese Patent Application No. 2007-182619, filed on Jul. 11, 2007; the entire contents of which are incorporated herein by reference.

### BACKGROUND OF THE INVENTION

1. Field of the Invention

The present invention relates to an information processing technique for converting a first program into a second program written in a machine language that is interpretable by a processor and also an information processing technique that uses a cache memory being operable to temporarily store therein data stored in a main memory.

2. Description of the Related Art

Conventionally, commonly-used processors are able to execute programs (i.e., object codes) that are written in a machine language specified by an instruction set architecture for each processor. On the other hand, in many cases, programmers perform programming processes by using a high-level programming language such as the C language that is easier to understand than machine languages. Thus, before a program is executed by a processor, it is necessary to convert the program written in a high-level programming language into object codes, by using a program converting means such as a compiler. Also, in some situations, object codes for a processor are converted into object codes for another processor, by using a program converting means such as a binary translator. For example, JP-A 2002-536712 (KOHYO) discloses a technique for converting, when a program is to be executed, object codes for a processor into object codes for another processor. Further, recently, some computers include a temporary storage device such as a cache memory or a local memory that is provided between the processor and the main memory and has a smaller capacity but has a higher performance of data supply than the main memory, so that it is possible to make the gap smaller between the performance of data processing of the processor and the performance of data supply of the main memory. In such a computer, it is possible to enhance the performance of data supply and to make use of the performance of data processing of the processor by temporarily storing the data stored in the main memory into the temporary storage device. However, because such a temporary storage device has a smaller capacity than the main memory, the temporary storage device is not able to store therein all of the data stored in the main memory. Thus, it is necessary to replace, as necessary, the data stored in the temporary storage device, according to the data access of the processor, or the like. The data transfer between the cache memory and the main memory is performed automatically. However, the data transfer between the local memory and the main memory is performed according to an explicit command from a program to a data transfer device.

The cache memory is divided into partial memory areas called cache lines. In the cache memory, the data is replaced in units of cache lines. When the processor performs an access process to access data stored in the main memory, a cache hit judgment process is performed so as to check to see if the data stored in the main memory is temporarily stored in the cache memory (This situation is known as a cache hit). In the cache hit judgment process, in a case where it has been judged that the data to be accessed is not temporarily stored in the cache memory, in other words, in a case where a cache miss has occurred, the data in the memory area that contains the data to be accessed is transferred from the main memory to the cache memory in units of cache lines. In this situation, if there is no free space in the cache lines in the cache memory, cache lines that are currently used and are temporarily storing therein other data need to be re-used. As a result, the data that has been stored in the cache memory will be replaced with some other data. Also, in a case where the data in the cache lines that will be re-used has been changed, the data stored in the cache lines will be transferred to the main memory before the cache lines are re-used.

As explained above, when the data is replaced according to a result of the cache hit judgment process that is performed every time an access process is performed, let us discuss a situation in which, for example, a plurality of access processes are performed to access pieces of data that are positioned adjacent to each other in the main memory and that use mutually the same cache line. In this situation, in a case where it is judged that a cache miss has occurred in a first access process, the data is replaced by transferring the data from the main memory to the cache line. As a result, in a second access process performed after the first access process, because the data has already been stored in the cache line, no cache miss occurs. It is therefore not necessary to replace the data.

However, in a conventional cache memory, in the case where a plurality of access processes to access mutually the same cache line are performed in parallel, if a cache miss has occurred in a first access process, a second access process performed after the first access process may be, in some situations, performed before the replacement of the data in the cache memory is completed. In such situations, there is a possibility that a cache miss may occur in the second access process, too.

### SUMMARY OF THE INVENTION

According to one aspect of the present invention, an information processing apparatus includes a program converting unit that converts a first program containing at least one instruction into a second program executable by a first information processing apparatus that includes a processor, a main memory, and a cache memory, the processor having a register operable to temporarily store data used while a program is executed, the main memory being operable to store a plurality of pieces of the data, the cache memory being divided in units of cache lines and in which at least one of the cache lines is used while the data is accessed; and an output unit that outputs the second program, wherein the program converting unit includes: a first instruction generating unit that generates a load cache instruction that represents an instruction to transfer to the register, stored data stored in at least one of the cache lines used while the data is accessed, with respect to a memory access instruction that is an instruction contained in the first program and represents an instruction to access to the data; a second instruction generating unit that generates a cache hit judgment instruction that represents an instruction to judge whether the data is stored in at least one of the cache lines used while the data is accessed, with respect to the memory access instruction; and a third instruction generating unit that generates a combine instruction instructing that judgment results obtained according to the cache hit judgment instructions generated with respect to the memory access instructions are combined into one judgment result, when the first program contains a plurality of memory access instructions having a possibility of using a mutually same cache line while the data is accessed.

According to another aspect of the present invention, an information processing apparatus includes a processor having a register operable to temporarily store data used while a program is executed; a main memory operable to store a plurality of pieces of the data; a local memory that has a memory area operable to temporarily store the data stored in the main memory; and a cache data controlling unit that performs a judgment process of judging whether the data is stored in the local memory, when the processor accesses the data while executing the program, and also performs, before completing the judgment process, a transfer process of transferring to the register, stored data stored in the memory area within the local memory used while the data is accessed, wherein the cache data controlling unit performs the judgment process and the transfer process in parallel that are performed with respect to a plurality of pieces of the data.

According to still another aspect of the present invention, an information processing apparatus includes a processor having a register operable to temporarily store data used while a program is executed; a main memory operable to store a plurality of pieces of the data; a local memory divided in units of cache lines and in which at least one of the cache lines is used while the data is accessed; a program converting unit that converts a first program containing at least one instruction into a second program written in a machine language that is interpretable by the processor; and a cache data controlling unit that performs a judgment process of judging whether the data is stored in the local memory, when the processor accesses the data while executing the program, and also performs, before completing the judgment process, a transfer process of transferring to the register, stored data stored in a memory area within the local memory being used while the data is accessed, wherein the program converting unit includes a first instruction generating unit, a second instruction generating unit, and a third instruction generating unit and generates the second program that contains at least a load cache instruction and a cache hit judgment instruction; the first instruction generating unit being operable to generate a load cache instruction that represents an instruction to transfer to the register, stored data stored in at least one of the cache lines used while the data is accessed, with respect to a memory access instruction that is an instruction contained in the first program and represents an instruction to access to the data; the second instruction generating unit being operable to generate a cache hit judgment instruction that represents an instruction to judge whether the data is stored in at least one of the cache lines used while the data is accessed, with respect to the memory access instruction; and the third instruction generating unit being operable to generate a combine instruction instructing that judgment results obtained according to the cache hit judgment instructions generated with respect to the memory access instructions are combined into one judgment result, when the first program contains a plurality of memory access instructions having a possibility of using a mutually same cache line while the data is accessed, and the cache data controlling unit performs the judgment process and the transfer process according to the cache hit judgment instruction and the load cache instruction that are contained in the second program, when the processor is executing the second program, and further the cache data controlling unit performs the judgment process and the transfer process in parallel that are performed with respect to the plurality of pieces of the data, when the processor uses a plurality of pieces of the data.

### BRIEF DESCRIPTION OF THE DRAWINGS

FIG. 1 is a block diagram illustrating an example of a computer system according to an embodiment of the present invention;

FIG. 2 is a block diagram illustrating an example of a host computer 101;

FIG. 3 is a block diagram illustrating examples of functional configurations realized when a processor 201 executes a program conversion program;

FIG. 4 is a diagram illustrating an example of a target computer 102;

FIG. 5 is a diagram illustrating examples of functions that are realized when a processor 401 executes a cache controlling program stored in a program memory 402;

FIG. 6 is a diagram illustrating an example of a data structure of a main memory address output by the processor 401;

FIG. 7 is a diagram illustrating an example of a local memory 403;

FIG. 8 is a diagram illustrating an example of a main memory 406;

FIG. 9 is a diagram illustrating an example of an internal representation program 305 that is output from an input program analyzing unit 302 shown in FIG. 3;

FIG. 10 is a flowchart of a procedure in a generating process performed by an output program generating unit 303 so as to analyze the internal representation program 305 and to generate an output program 103;

FIG. 11 is a flowchart of a procedure in a process of generating a cache memory access instruction instructing that a single memory access should be performed;

FIG. 12 is a drawing illustrating an example of a cache memory access instruction that has been generated as a result of the process at step S806;

FIG. 13 is a flowchart of a procedure in a process of generating a cache memory access instruction instructing that a plurality of memory accesses should be performed;

FIG. 14 is a drawing illustrating an example of a cache memory access instruction that has been generated as a result of the process at step S804; and

FIG. 15 is a drawing illustrating another example of the cache memory access instruction that has been generated as a result of the process at step S804.

### DETAILED DESCRIPTION OF THE INVENTION

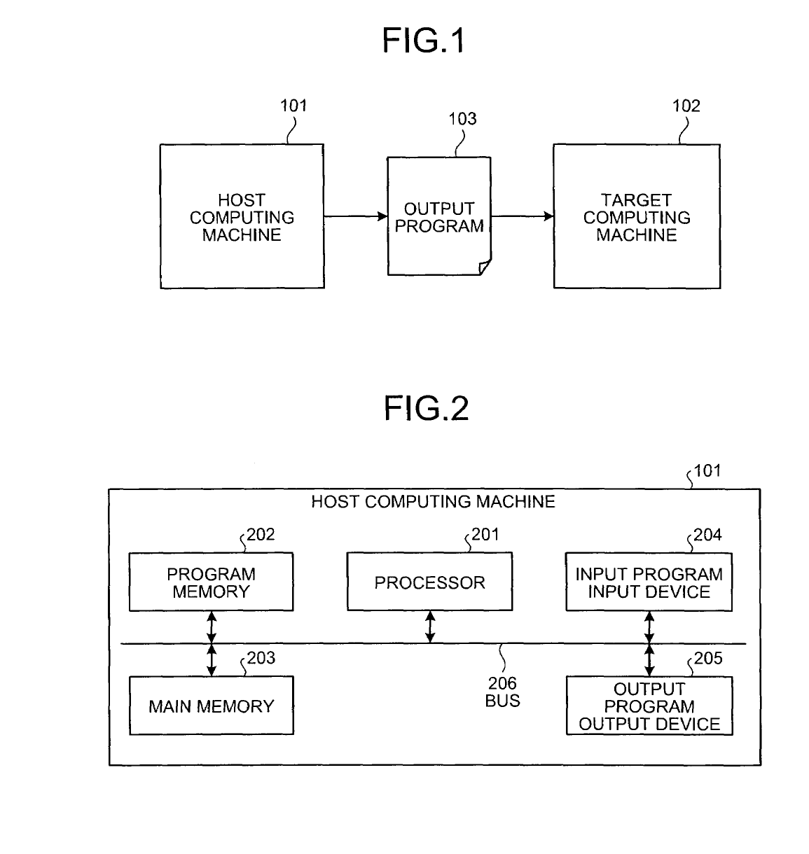

FIG. 1 is a block diagram illustrating an example of a computer system according to an embodiment of the present invention. The computer system includes a host computer 101 and a target computer 102. The host computer 101 generates, from an input program that has been input thereto, an output program 103 written in a machine language that is interpretable by the target computer 102 and outputs the generated output program 103. The target computer 102 executes the output program 103. It is acceptable to output the output program 103 by using a recording medium such as a floppy (a registered trademark) disk or a Compact Disk Recordable (CD-R). Alternatively, another arrangement is acceptable in which the host computer 101 and the target computer 102 are connected to each other by a communication path so that the output program 103 is output via the communication path. Further alternatively, it is acceptable to configure the host computer 101 and the target computer 102 with a single computer.

The input program may be a program that is written in a high-level programming language such as the C language. Alternatively, the input program may be a program that is written in a machine language specified by an instruction set architecture for a predetermined processor.

FIG. 2 is a block diagram illustrating an example of the host computer 101. The host computer 101 includes a processor 201, a program memory 202, a main memory 203, an input program input device 204, an output program output device 205, and a bus 206. The processor 201 is connected to the program memory 202, the main memory 203, the input program input device 204, and the output program output device 205 via the bus 206. The processor 201 executes a program stored in the program memory 202 or a program stored in the main memory 203. The program memory 202 is a memory that is used for storing therein the program executed by the processor 201. The program memory 202 may be configured with, for example, a Read-Only Memory (ROM). The program memory 202 also stores therein a program conversion program used for generating the output program from the input program. The program conversion program will be explained in detail later. The main memory 203 is a memory that is used for storing therein the program executed by the processor 201 and the data used while the program is being executed. The main memory 203 may be configured with, for example, a Random Access Memory (RAM). The input program input device 204 is an input device used for inputting the input program. The input program input device 204 may be configured with, for example, a keyboard, a floppy (a registered trademark) disk drive, or a Compact Disk Read-Only Memory (CD-ROM) drive. The output program output device 205 is an output device used for outputting the output program generated from the input program that has been input by the input program input device 204. The output program output device 205 may be configured with, for example, a floppy (a registered trademark) disk drive or a CD-R drive.

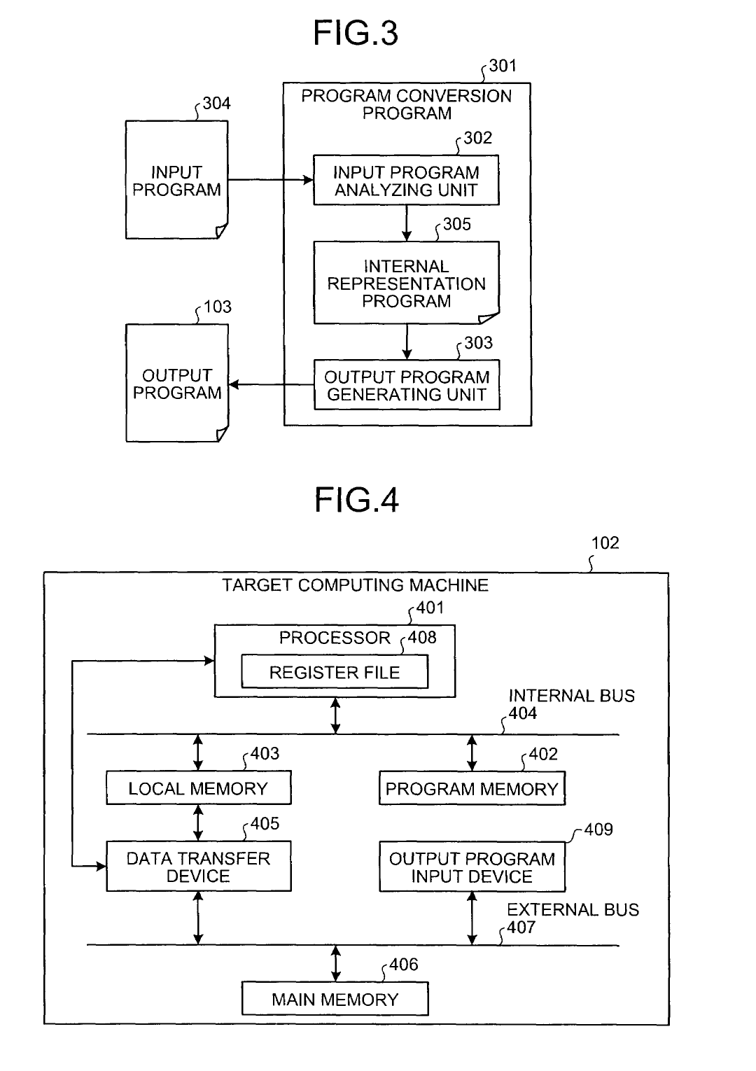

Next, the functions that are realized when the processor 201 included in the host computer 101 executes the program conversion program mentioned above will be explained. FIG. 3 is a block diagram illustrating examples of functional configurations realized when the processor 201 executes the program conversion program. As shown in the drawing, the functions of an input program analyzing unit 302 and an output program generating unit 303 are realized by a program conversion program 301. The input program analyzing unit 302 receives an input of an input program 304 that has been input by the input program input device 204 and analyzes the input program 304 so as to output an internal representation program 305, which is a program written in a data representation format for an internal process. The output program generating unit 303 analyzes the internal representation program 305 that has been output by the input program analyzing unit 302 and generates and outputs the output program 103 that is executable by the target computer 102.

More specifically, with respect to memory access instructions that are instructions contained in the internal representation program and each of which instructs that the data being a process target should be accessed, the output program generating unit 303 generates instructions (a), (b), and (d) as shown below and outputs the output program 103 that contains the instructions (a), (b), and (d). Further, according to the present embodiment, in correspondence with a condition satisfied by the instructions contained in the internal representation program, the output program generating unit 303 generates, as necessary, a combine instruction (c) as shown below and outputs the output program 103 that contains the combine instruction (c). It should be noted that the main memory, the local memory, and the register described below are included in the information processing apparatus (i.e., the target computer 102 in the present example) that executes the output program 103. The configurations of the main memory, the local memory, and the register included in the target computer 102 and specific examples of the output program 103 will be described later.

(a) A load cache instruction instructing that the data that is stored in a cache line within the local memory being used in correspondence with an address within the main memory (i.e., a main memory address) of the data being the process target should be transferred to the register;

(b) A cache hit judgment instruction instructing that it should be judged whether the data being the process target is stored in the local memory, in other words, whether the data being the process target is stored in the cache line within the local memory being used in correspondence with the main memory address;

(c) A combine instruction instructing that, in a case where the internal representation program contains a plurality of memory access instructions having a possibility of using mutually the same cache line when the data being the process target is accessed, judgment results of the judgment processes that are performed according to a cache hit judgment instruction should be combined into one judgment result; and

(d) A cache miss instruction instructing that, in a case where a judgment result of the judgment process that is performed according to the cache hit judgment instruction or a judgment result that has been combined according to the combine instruction indicates that the data being the process target is not stored in the cache line as described above, the data being the process target should be transferred from the main memory to the local memory and should be subsequently transferred from the local memory to the register.

FIG. 4 is a diagram illustrating an example of the target computer 102. The target computer 102 includes a processor 401, a program memory 402, a local memory 403, an internal bus 404, a data transfer device 405, a main memory 406, an external bus 407, and an output program input device 409. The processor 401 is connected to the program memory 402 and the local memory 403 via the internal bus 404. The data transfer device 405 is connected to the processor 401 and the local memory 403, and is further connected to the main memory 406 via the external bus 407.

The processor 401 includes a register file 408 and uses it as a storage area for input data and output data that are used in operating processes. The register file 408 includes a plurality of registers. The processor 401 executes a program stored in the program memory 402 or a program stored in the local memory 403. The processor 401 also controls the data transfer device 405. The program memory 402 is a memory that is used for storing therein the program executed by the processor 401. The program memory 402 may be configured with, for example, a Read-Only Memory (ROM). The program memory 402 also stores therein a cache memory controlling program, which is explained later. The local memory 403 is a memory that is used for storing therein the program executed by the processor 401 and the data used while the program is being executed. The local memory 403 may be configured with, for example, a Random Access Memory (RAM). Under the control of the processor 401, the data transfer device 405 transfers a piece of data having a specified size from the local memory 403 to the main memory 406 or from the main memory 406 to the local memory 403. It is acceptable to use, for example, a direct memory access controller (DMA controller) as the data transfer device 405. The output program input device 409 is an input device used for inputting the output program 103 that has been output from the host computer 101 to the local memory 403. The output program input device 409 may be configured with, for example, a keyboard, a floppy (a registered trademark) disk drive, or a CD-ROM drive.

According to the present embodiment, the processor 401 is configured so as not to be able to directly access the main memory 406. However, another arrangement is acceptable in which the processor 401 is able to directly access the main memory. In that situation, it is desirable to have an arrangement in which an access time of the local memory 403 is shorter than an access time of the main memory 406.

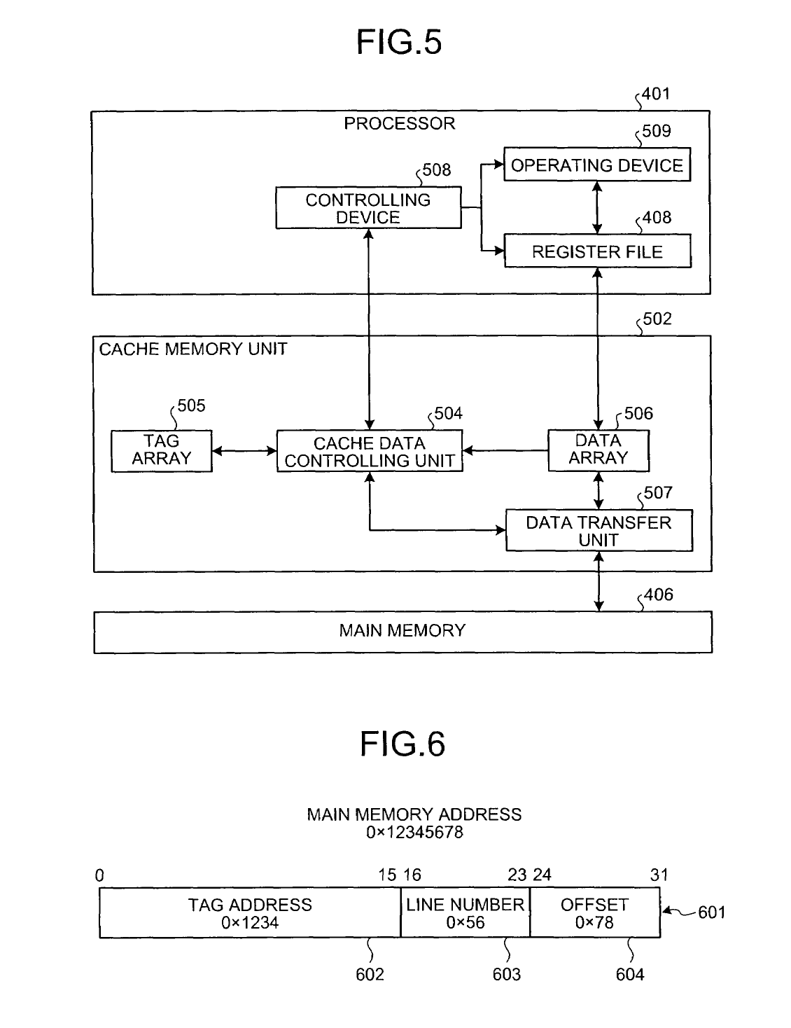

Next, the functions that are realized when the processor 401 executes the cache controlling program described above that is stored in the program memory 402 will be explained. FIG. 5 is a diagram illustrating examples of the functions that are realized when the processor 401 executes the cache controlling program stored in the program memory 402. A cache data controlling unit 504 represents the functions that are realized when the processor 401 executes the cache controlling program. A tag array 505 and a data array 506 are memories that are provided in the local memory 403. The tag array 505 is operable to store therein information used for managing the data in the data array 506. The data array 506 is operable to temporarily store therein the data in the main memory 406. A data transfer unit 507 is configured with the data transfer device 405 described above. A cache memory unit 502 shown in the diagram is configured so as to include the cache data controlling unit 504, the tag array 505, the data array 506, and the data transfer unit 507. The cache memory unit 502 is connected to the processor 401 and the main memory 406 and provides a means used by the processor 401 to access the data in the main memory 406.

The processor 401 described above further includes a controlling device 508 and an operating device 509, in addition to the register file 408. In a case where the processor 401 is to access the data stored in the main memory 406 while executing a program, the controlling device 508 issues an access request to the cache memory unit 502. In that situation, in a case where the processor 401 accesses the main memory 406 so as to write data thereto, the processor 401 outputs data in a register within the register file 408 to the cache memory unit 502. In a case where the processor 401 accesses the main memory 406 so as to read data therefrom, the processor 401 stores (i.e., copies) the data in the cache memory unit 502 into a register within the register file 408. The operating device 509 performs an operating process by using the data stored in the register within the register file 408 and stores a result of the operating process into a register within the register file 408.

In the configuration described above, the cache data controlling unit 504 is connected to the controlling device 508 included in the processor 401 as well as to the tag array 505, the data array 506, and the data transfer unit 507. When having received the access request from the processor 401, the cache data controlling unit 504 controls the access process that is performed in response to the access request. During the access process, the cache data controlling unit 504 manages the data in the data array 506 by using the tag array 505, and also controls the data transfer between the data array 506 and the main memory 406 via the data transfer unit 507.

FIG. 6 is a diagram illustrating an example of a data structure of a main memory address output by the processor 401. A main memory address 601 is configured so as to have 32 bits and includes a tag address 602 having a width of 16 bits, a line number 603 having a width of 8 bits, and an offset 604 having a width of 8 bits. For example, in a case where the main memory address 601 is “0x12345678”, the tag address 602 is “0x1234”, while the line number 603 is “0x56”, and the offset 604 is “0x78”. It is acceptable to use any bit width for the main memory address 601 as long as the address is applicable to a capacity that is larger than the capacity of the main memory 406. For example, in a case where the main memory address 601 has a width of 32 bits, and it is possible to access the main memory 406 in units of one byte, it is possible to apply the main memory address 601 to a capacity of up to a maximum of 4 gigabytes (GB). Also, because the line number 603 has a width of 8 bits, it is possible to use line numbers from “0” to “255”.

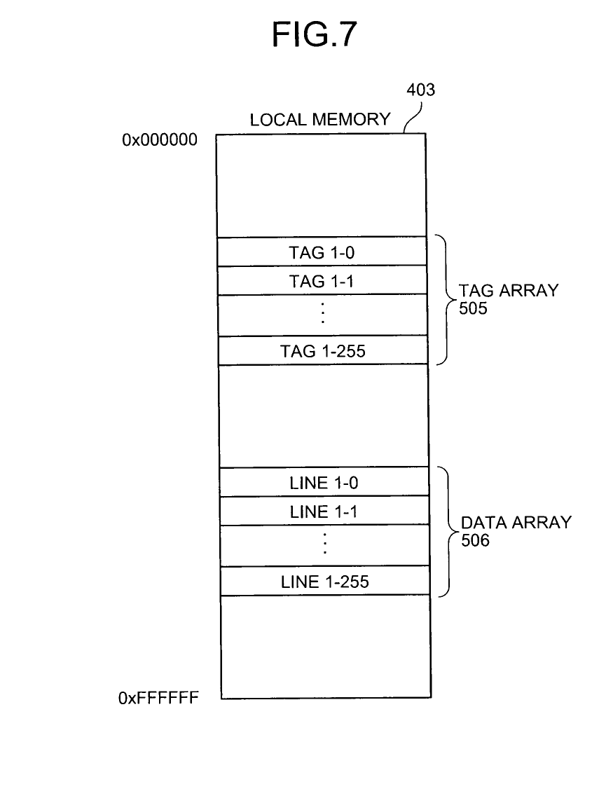

FIG. 7 is a diagram illustrating an example of the local memory 403. In this diagram, the cache lines in the data array and the tags (i.e., management information) in the tag array are each expressed by using the forms of “LINE ‘way number’-‘line number’” and “TAG ‘way number’-‘line number’”, respectively. For example, “LINE 1-255” denotes a cache line of which the way number is “1” and the line number is “255 (0xFF)”.

The local memory 403 stores therein the data array 506 that temporarily stores therein, in correspondence with each of the cache lines, the data in the main memory 406 (the capacity of each cache line is 256 bytes) and the tag array 505 that stores therein, in correspondence with each of the cache lines, the tags (i.e., the management information) of the data stored in the data array 506. Local memory addresses from “0x000000” through “0xFFFFFF” are assigned to the local memory 403. For example, let us assume that the capacity of the local memory 403 is 16 megabytes (MB), and it is possible to specify each piece of one-byte data stored in the local memory 403 by using a different one of the local memory addresses.

The line number in the main memory address is used for identifying one of the cache lines in the data array 506. The tag address in the main memory address is used for identifying data stored in a cache line in the data array 506. An offset is used for identifying in which place of a row of bytes (e.g., the first byte, the second byte, etc.) a piece of data is positioned, among the data (having 256 bytes) stored in a cache line in the data array 506.

The number of cache lines included in the data array 506 is equal to the number of tags included in the tag array 505. To keep the explanation simple, the data array 506 and the tag array 505 each have one way in FIG. 7; however, it is acceptable to configure the data array 506 and/or the tag array 505 so as to have a plurality of ways.

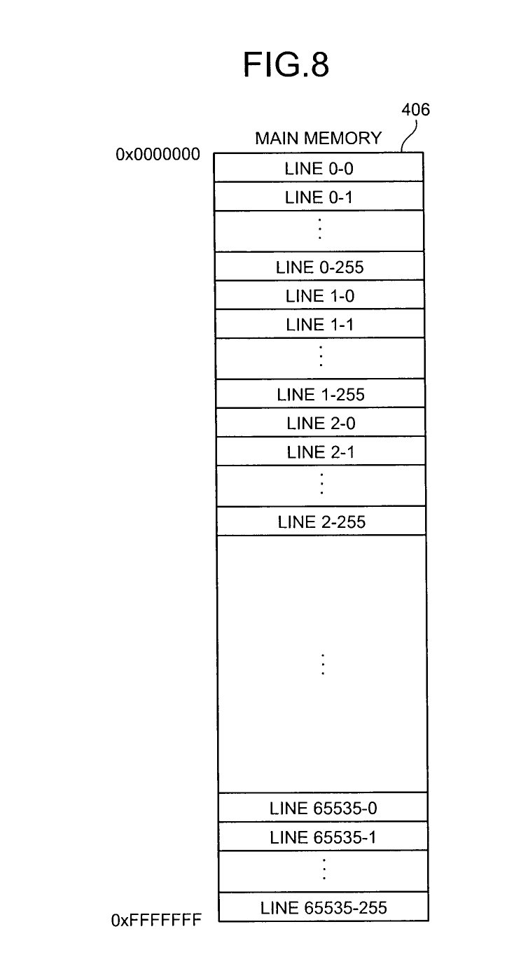

FIG. 8 is a diagram illustrating an example of the main memory 406. The main memory 406 is divided in units of cache lines. Also, the cache lines are organized into groups, so that each group has as many cache lines as the number of cache lines included in the data array 506 in the local memory 403. To each of the cache lines included in the main memory 406 shown in FIG. 8, a cache line number indicating “a group number-a cache line number” is assigned. When an access is made to one of the cache lines in the main memory 406, one of the cache lines in the data array 506 having assigned thereto a cache line number that is equal to the cache line number assigned to the cache line in the main memory 406 will be used. Accordingly, for example, in a case where accesses are made to the cache line “0-0”, the cache line “1-0”, the cache line “2-0”, and the cache line “65535-0” in the main memory 406, the cache line “0-0” in the data array 506 will be used for each of all these accesses.

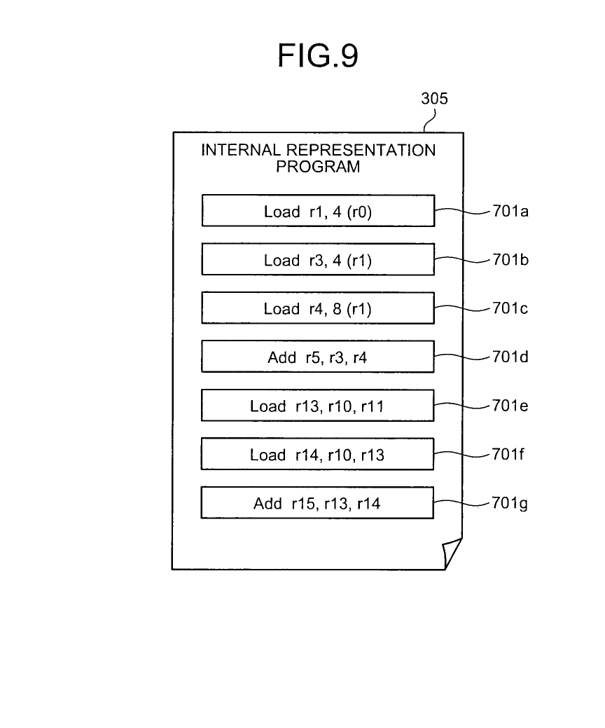

FIG. 9 is a diagram illustrating an example of the internal representation program 305 that is output from the input program analyzing unit 302 shown in FIG. 3. The internal representation program 305 contains internal representation codes 701a, 701b, 701c, 701d, 701e, 701f, and 701g. The internal representation codes 701a, 701b, and 701c are each an example of a load instruction that uses a first register indirect addressing mode and instructs that data should be loaded into a register from an address in the main memory 406 obtained by adding an offset value to a base address register value. The internal representation code 701a is an instruction instructing that data should be loaded from an address obtained by adding an offset value “4” to the value in a register r0, which is a base address register, and should be set into a register r1. The internal representation code 701b is an instruction instructing that data should be loaded from an address obtained by adding an offset value “4” to the value in the register r1, which is a base address register, and should be set into a register r3. The internal representation code 701c is an instruction instructing that data should be loaded from an address obtained by adding an offset value “8” to the value in the register r1, which is a base address register, and should be set into a register r4.

The internal representation codes 701d and 701g are each an example of an instruction instructing that two register values should be added together. The internal representation code 701d is an instruction instructing that the value in the register r3 and the value in the register r4 should be added together and set into a register r5. The internal representation code 701g is an instruction instructing that the value in a register r13 and the value in a register r14 should be added together and set into a register r15.

The internal representation codes 701e and 701f are each an example of a load instruction that uses a second register indirect addressing mode and instructs that data should be loaded, into a register, from an address in the main memory 406 obtained by adding an offset register value to a base address register value. The internal representation code 701e is an instruction instructing that data should be loaded from an address obtained by adding the value in a register r11, which is an offset register, to the value in a register r10, which is a base address register, and should be set into the register r13. The internal representation code 701f is an instruction instructing that data should be loaded from an address obtained by adding the value in the register r13, which is an offset register, to the value in the register r10, which is a base address register, and should be set into the register r14.

The internal representation program 305 that is described above as an example includes one basic block that contains the internal representation codes 701a through 701g. However, according to the present embodiment, another arrangement is acceptable in which the internal representation program 305 includes a plurality of basic blocks. The basic block in this situation is a process block obtained by dividing the program in units of predetermined processes. Examples of the predetermined processes include a loop process and a branch process.

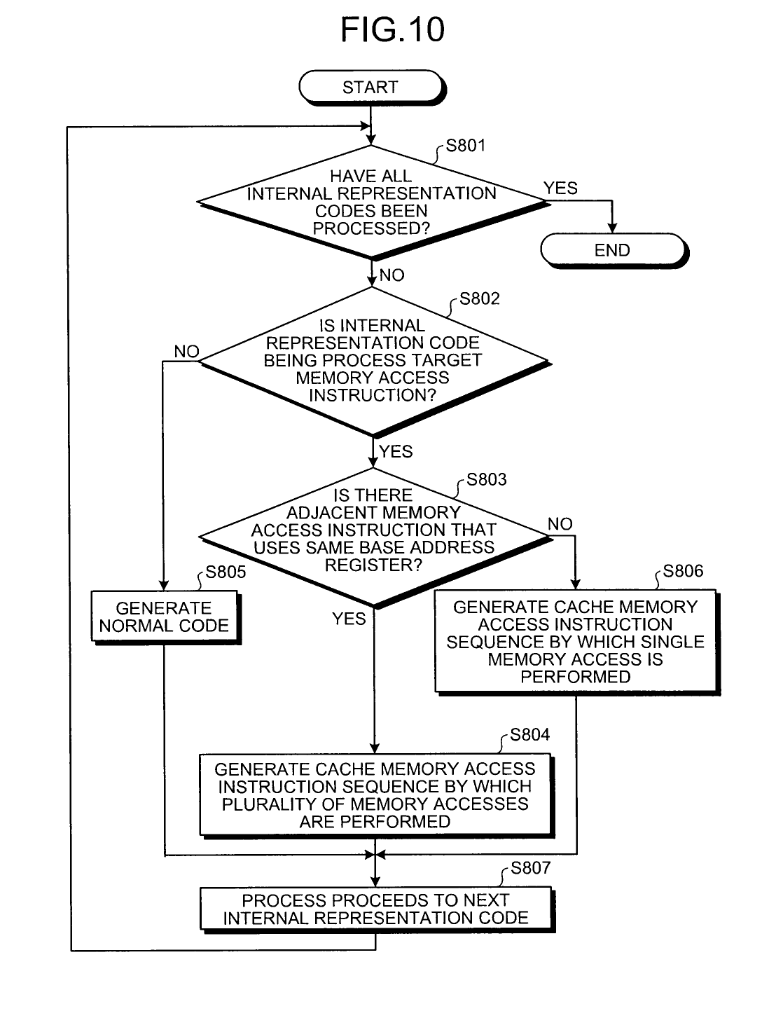

Next, a process that is performed by the host computer 101 according to the present embodiment to output the output program will be explained. As explained above, when the processor 201 included in the host computer 101 as shown in FIG. 2 executes the program conversion program, the functions of the input program analyzing unit 302 and the output program generating unit 303 shown in FIG. 3 are realized. In the following sections, a procedure in a generating process performed by the output program generating unit 303 so as to analyze the internal representation program 305 and to generate the output program 103 will be explained in detail, the internal representation program 305 having been output after the input program analyzing unit 302 analyzes the input program 304 that had been received as an input. FIG. 10 is a flowchart of the procedure in the generating process performed by the output program generating unit 303 so as to analyze the internal representation program 305 and to generate the output program 103.

First, the output program generating unit 303 judges whether all the internal representation codes that are contained in the internal representation program 305 have been processed (step S801). If it is judged that all of the internal representation codes have been processed (step S801: Yes), the generating process is ended. If it is judged that not all the internal representation codes have been processed (step S801: No), the output program generating unit 303 judges whether an internal representation code being a process target is a memory access instruction such as a load instruction (step S802). When the judgment result is in the negative, the output program generating unit 303 generates a normal code (i.e., a code in a machine language) that corresponds to the internal representation code (step S805). In a case where the internal representation code being the process target is a memory access instruction (step S802: Yes), the output program generating unit 303 judges whether there is any internal representation code that is positioned adjacent to the internal representation code being the process target (hereinafter, an “adjacent internal representation code”) and represents a memory access instruction that uses the same base address register (step S803). In other words, the output program generating unit 303 judges whether there are a plurality of memory access instructions having a possibility of causing accesses to mutually the same cache line.

In this situation, the “adjacent internal representation code” satisfies one of the following conditions (a), (b), and (c):

(a) An internal representation codes that is contained in the same basic block within the internal representation program 305 as the internal representation code being the process target;

(b) One or more internal representation codes defined in (a) that follow the internal representation code being the process target;

(c) An internal representation code defined in (b) that has no first type of internal representation code placed between the internal representation code that is a memory access instruction being the process target and itself, the first type of internal representation code being an instruction instructing that the value in a register used by the internal representation code being the process target should be changed.

In the present example, it is judged whether the memory access instructions have a possibility of causing accesses to mutually the same cache line, based on whether the memory access instructions use mutually the same base address register. However, instead of performing the judgment process based on the base address register, it is acceptable to perform the judgment process based on the base address register and an offset register, or whether the offset registers to be used are mutually the same.

In a case where there is at least one adjacent representation code being a memory access instruction that uses the same base address register (step S803: Yes), the output program generating unit 303 generates a cache memory access instruction instructing that a plurality of memory accesses should be performed (step S804), and the process proceeds to step S807. In a case where there is no adjacent internal representation code being a memory access instruction that uses the same base address register (step S803: No), the output program generating unit 303 generates a cache memory access instruction instructing that a single memory access should be performed (step S806), and the process proceeds to step S807. At step S807, the output program generating unit 303 proceeds ahead to process the next internal representation code and continues the process starting from step S801.

For example, with the internal representation program 305 shown in FIG. 9, in a case where the internal representation code being the process target is the internal representation code 701a, the output program generating unit 303 generates, based on the internal representation code 701a, a cache memory access instruction instructing that a single memory access should be performed. In a case where the internal representation code being the process target is the internal representation code 701b, the adjacent internal representation code thereof is the internal representation code 701c. Thus, the output program generating unit 303 generates, based on the internal representation codes 701b and 701c, a cache memory access instruction instructing that a plurality of memory accesses should be performed. Also, in a case where the internal representation code being the process target is the internal representation code 701e, the adjacent internal representation code thereof is the internal representation code 701f. Thus, the output program generating unit 303 generates, based on the internal representation codes 701e and 701f, a cache memory access instruction instructing that a plurality of memory accesses should be performed.

The output program that is generated by the output program generating unit 303 is configured so that the processor 401 included in the target computer 102 executes, in parallel, (a) a judgment process (i.e., a cache hit judgment process) of judging whether the data to be accessed has already been stored in the local memory 403 included in the target computer 102 and (b) a copying process (i.e., a pre-loading process) of copying the data stored in the local memory 403 into a register before the cache hit judgment process is completed. In this configuration, the processor 401 included in the target computer 102 executes, in parallel, the pre-loading process and the cache hit judgment process. Thus, the time (i.e., a data access time) it takes for the processor 401 to access the data stored in the local memory 403 is shorter than the time it takes for the processor 401 to access the data by performing a normal loading process after completing the cache hit judgment process. In other words, compared to the case where the processor 401 performs the normal loading process after completing the cache hit judgment process, it is possible to eliminate, from the data access period, the shorter one of the time it takes to perform the pre-loading process and the time it takes to perform the cache hit judgment process.

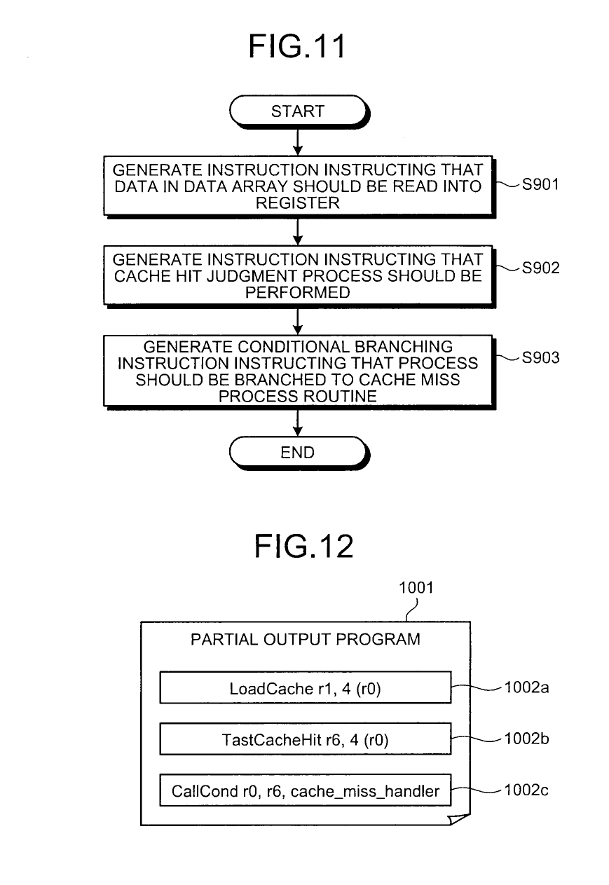

Next, the procedure at step S806 in the process of generating the cache memory access instruction instructing that a single memory access should be performed will be explained. FIG. 11 is a flowchart of the procedure in the process of generating the cache memory access instruction instructing that a single memory access should be performed.

First, by using a main memory address, the output program generating unit 303 generates an instruction (i.e., a load cache instruction) instructing that data in the data array 506 should be read into a register (step S901). Next, the output program generating unit 303 generates an instruction (i.e., a cache hit judgment instruction) instructing that it should be judged whether the data stored at the main memory address is stored in the data array 506 (step S902). Lastly, the output program generating unit 303 generates a conditional branching instruction instructing that, in a case where it has been judged that the data stored at the main memory address is not stored in the data array 506, in other words, in a case where the judgment result indicates that a cache miss has occurred, the process should be branched to a cache miss process routine for performing a cache miss process (step S903). The cache miss process is a process to store (i.e., to copy) the data being the target of the cache hit judgment process into the data array 506.

FIG. 12 is a drawing illustrating an example of a cache memory access instruction that has been generated as a result of the process at step S806. A partial output program 1001 shown in the drawing is a part of the output program 103 and has been generated as a result of processing the internal representation code 701a. An output code 1002a is a first load cache instruction and instructs that the data stored in one of the cache lines in the data array 506 that corresponds to an address in the main memory 406 that is obtained by adding an offset value to a base address register value should be loaded. More specifically, the output code 1002a instructs that the data should be loaded from an address within the data array 506 obtained by adding an offset value “4” to the value in the register r0, which is a base address register, and should be set into the register r1. In this situation, according to the load cache instruction, the process can be continued in parallel with a following instruction, and the following instruction can be executed even if the process has not been completed. According to the present embodiment, the load cache instruction is written in a single machine language; however, another arrangement is acceptable in which the same functions are realized by a combination of a plurality of machine languages.

An output code 1002b is a first cache hit judgment instruction and instructs that it should be judged whether the data stored at an address within the main memory 406 obtained by adding an offset value to a base address register value is stored in the corresponding one of the cache lines in the data array 506, and that the judgment result should be set into a specified register. More specifically, the output code 1002b instructs that it should be judged whether the data stored at the address obtained by adding an offset value “4” to the value in the register r0, which is a base address register value, is stored in the corresponding one of the cache lines in the data array 506, and that “0” should be set into a register r6 if the data is stored, and “1” should be set into the register r6, if the data is not stored. According to the present embodiment, the cache hit judgment instruction is written in a single machine language; however, another arrangement is acceptable in which the same functions are realized by a combination of a plurality of machine languages.

An output code 1002c is a conditional branching instruction and instructs that, in a case where the value in a conditional register is “1”, the address of a following instruction should be set into a return address register so that the process branches to a specified address. More specifically, the output code 1002c instructs that, in a case where the value in the register r6, which is a conditional register, is “1”, the address of the following instruction should be set into the register r0, which is a return address register, so that the process branches to the specified address expressed as “cache_miss_handler”. The address “cache_miss_handler” is an address for the cache miss process routine.

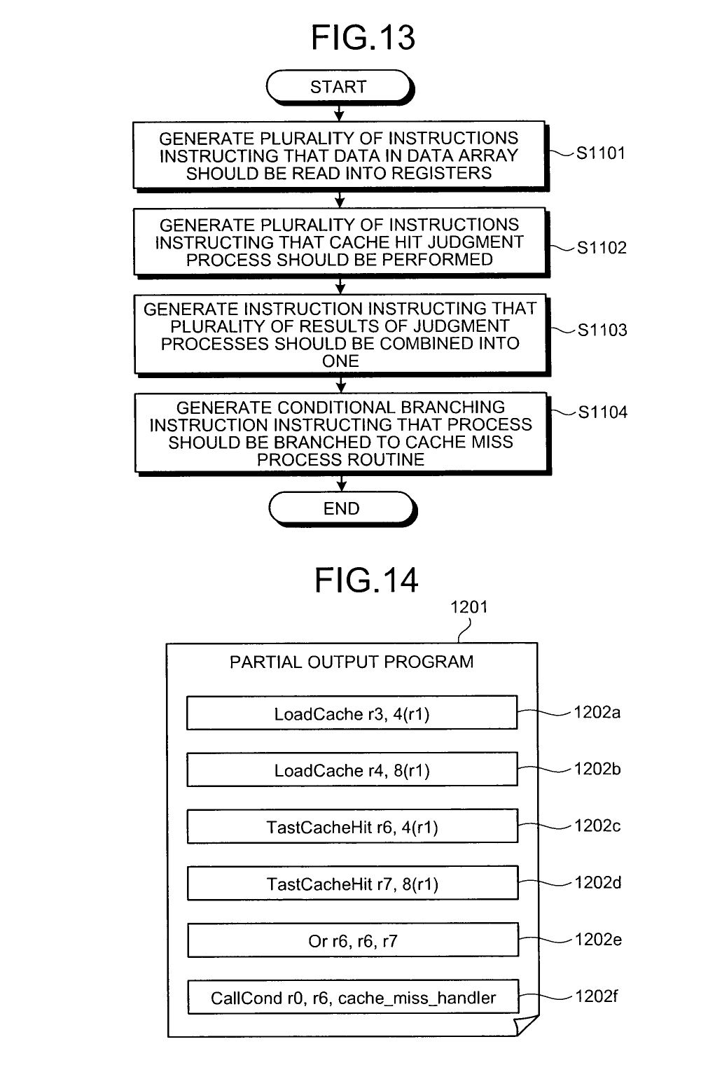

Next, a procedure in the process at step S804 to generate the cache memory access instruction instructing that a plurality of memory accesses should be performed will be explained. FIG. 13 is a flowchart of the procedure in the process of generating the cache memory access instruction instructing that a plurality of memory accesses should be performed.

First, with respect to all the memory access instructions being the targets, the output program generating unit 303 generates, by using each of the main memory addresses, a plurality of instructions (i.e., load cache instructions) instructing that the data stored in the data array 506 should be read into registers (step S1101). Next, with respect to all the memory access instructions being the targets, the output program generating unit 303 generates a plurality of instructions (i.e., cache hit judgment instructions) instructing that it should be judged whether the data stored at the main memory addresses is stored in the data array 506 (step S1102). Further, the output program generating unit 303 generates an instruction instructing that a plurality of judgment results should be combined into one judgment result (step S1103). Lastly, the output program generating unit 303 generates a conditional branching instruction instructing that, in a case where the judgment result indicates that a cache miss has occurred, the process should be branched to the cache miss process routine (step S1104).

FIG. 14 is a drawing illustrating an example of the cache memory access instruction that has been generated as a result of the process at step S804. A partial output program 1201 shown in the drawing is a part of the output program 103 and has been generated as a result of processing the internal representation codes 701b and 701c. An output code 1202a is a first load cache instruction and instructs that the data should be loaded from an address within the data array 506 obtained by adding an offset value “4” to the value in the register r1, which is a base address register, and should be set into the register r3.

An output code 1202b is a first load cache instruction and instructs that the data should be loaded from an address within the data array 506 obtained by adding an offset value “8” to the value in the register r1, which is a base address register, and should be set into the register r4.

An output code 1202c is a first cache hit judgment instruction and instructs that it should be judged whether the data at the address obtained by adding an offset value “4” to the value in the register r1, which is a base address register, is stored in a corresponding one of the cache lines in the data array 506 and that “O” should be set into the register r6 if the data is stored, and “1” should be set into the register r6 if the data is not stored.

An output code 1202d is a first cache hit judgment instruction and instructs that it should be judged whether the data at the address obtained by adding an offset value “8” to the value in the register r1, which is a base address register, is stored in a corresponding one of the cache lines in the data array 506 and that “0” should be set into a register r7 if the data is stored, and “1” should be set into the register r7 if the data is not stored.

An output code 1202e is an example in which a logical OR instruction is used as a combine instruction instructing that a plurality of judgment results should be combined into one judgment result. The output code 1202e instructs that a logical OR of the value in the register r6 and the value in the register r7 should be calculated and that the result of the calculation should be set into the register r6.

An output code 1202f instructs that, in the case where the value in the register r6, which is a conditional register, is “1”, the address of the following instruction should be set into the register r0, which is a return address register, and that the process should be branched to the specified address expressed as “cache_miss_handler”.

As explained above, the output program generating unit 303 puts the instructions into one partial output program 1201, the instructions including the output code 1202e instructing that the judgment results of the cache hit judgment instructions (i.e., the output codes 1202c and 1202d in the present example) with respect to the plurality of memory access instructions (i.e., the output codes 1202a and 1202b in the present example) having a possibility of causing accesses to mutually the same cache line should be combined into one judgment result and the instruction that the cache miss process should be performed according to the combined judgment result.

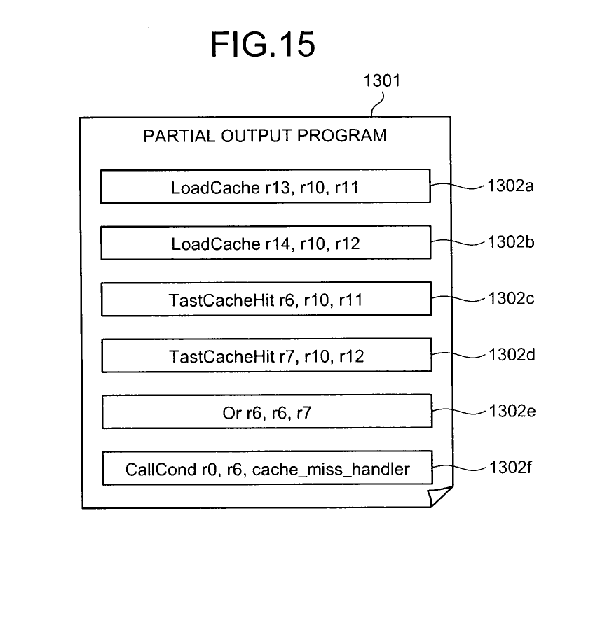

Another example of a cache memory access instruction that has been generated as a result of the process at step S804 will be explained. FIG. 15 is a drawing illustrating another example of a cache memory access instruction that has been generated as a result of the process at step S804. A partial output program 1301 shown in the drawing is a part of the output program 103 and has been generated as a result of processing the internal representation codes 701e and 701f.

An output code 1302a and an output code 1302b are each a second load cache instruction instructing that the data stored in one of the cache lines in the data array 506 that corresponds to an address in the main memory 406 obtained by adding an offset register value to a base address register value should be loaded. More specifically, the output code 1302a instructs that the data should be loaded from an address within the data array 506 obtained by adding the value in the register r11, which is an offset register, to the value in the register r10, which is a base address register, and should be set into the register r13. The output code 1302b instructs that the data should be loaded from an address within the data array 506 obtained by adding the value in a register r12, which is an offset register, to the value in the register r10, which is a base address register, and should be set into the register r14.

An output code 1302c and an output code 1302d are each a second cache hit judgment instruction instructing that it should be judged whether the data stored at an address within the main memory 406 obtained by adding an offset register value to a base address register value is stored in a corresponding one of the cache lines in the data array 506 and that the judgment result should be set into a specified register. More specifically, the output code 1302c instructs that it should be judged whether the data stored at the address obtained by adding the value in the register r11, which is an offset register, to the value in the register r10, which is a base address register, is stored in a corresponding one of the cache lines in the data array 506, and that “0” should be set into the register r6 if the data is stored, and “1” should be set into the register r6, if the data is not stored. The output code 1302d instructs that it should be judged whether the data stored at the address obtained by adding the value in the register r12, which is an offset register, to the value in the register r10, which is a base address register, is stored in a corresponding one of the cache lines in the data array 506, and that “0” should be set into the register r7 if the data is stored, and “1” should be set into the register r7, if the data is not stored.

An output code 1302e is an example in which a logical OR instruction is used as a combine instruction instructing that a plurality of judgment results should be combined into one judgment result. The output code 1302e instructs that a logical OR of the value in the register r6 and the value in the register r7 should be calculated and that the result of the calculation should be set into the register r6. An output code 1302f instructs that, in the case where the value in the register r6, which is a conditional register, is “1”, the address of the following instruction should be set into the register r0, which is a return address register, and that the process should be branched to the specified address expressed as “cache_miss_handler”.

As explained above, the output program generating unit 303 analyzes the internal representation program 305 and generates the output program 103 that contains the various types of instructions, so as to generate the output program 103 from the internal representation program 305. The output program 103 is output to the target computer 102 via the output program output device 205. The target computer 102 inputs the output program 103 to the local memory 403 via the output program input device 409. Subsequently, the processor 401 included in the target computer 102 reads the output program 103 from the local memory 403 when executing the output program 103. As explained above, the output program 103 contains operation instructions in addition to the load cache instructions and the cache hit judgment instructions that correspond to the memory access instructions. Accordingly, the processor 401 performs the processes according to the various types of instructions that are contained in the output program 103.

Next, a procedure in a process that is performed when the processor 401 included in the target computer 102 executes the output program 103 will be explained. The processor 401 executes the output program 103 stored in the local memory 403, and also executes a cache data controlling program. Thus, when performing a process according to a memory access instruction contained in the output program 103, the processor 401 executes, in parallel, the cache hit judgment process and the pre-loading process according to the cache data controlling program.

More specifically, for example, in the partial output program 1201 shown in FIG. 14, which is a part of the output program 103, the processor 401 starts loading the data (i.e., performs a pre-loading process) stored in a corresponding one of the cache lines in the data array 506 according to a load cache instruction (i.e., the output code 1202a) that corresponds to the internal representation code 701b, which is a memory access instruction contained in the internal representation program 305. After that, before the pre-loading process is completed, the processor 401 starts a cache hit judgment process according to a cache hit judgment instruction (i.e., the output code 1202c) that corresponds to the load cache instruction (i.e., the output code 1202a).

As explained above, because the processor 401 starts performing the pre-loading process before completing the cache hit judgment process, the processor 401 is able to execute the pre-loading process and the cache hit judgment process in parallel. Consequently, it is possible to shorten the data access time.

Further, the processor 401 starts loading the data (i.e., performs a pre-loading process) stored in a corresponding one of the cache lines in the data array 506 according to a load cache instruction (i.e., the output code 1202b) that corresponds to the internal representation code 701c, which is a memory access instruction contained in the internal representation program 305. After that, before completing the pre-loading process, the processor 401 starts a cache hit judgment process according to a cache hit judgment instruction (i.e., the output code 1202d) that corresponds to the load cache instruction (i.e., the output code 1202b).

In other words, in this situation, the processor 401 executes, in parallel, the pre-loading process and the cache hit judgment process for the internal representation code 701b and the pre-loading process and the cache hit judgment process for the internal representation code 701c. With this arrangement, it is possible to further shorten the data access period.

Also, in this situation, in a case where there are a plurality of memory access instructions having a possibility of causing accesses to mutually the same cache line, the results of the cache hit judgment processes for the memory access instructions are combined into one judgment result. The processor 401 performs the cache miss process according to the combined judgment result. More specifically, the judgment results of the cache hit judgment processes that are performed according to the output codes 1202c and 1202d are combined into one judgment result according to the output code 1202e. After that, according to the combined judgment result, the processor 401 performs the cache miss process according to the output code 1202f.

Next, the procedure in the process performed by the processor 401 to perform the cache miss process will be explained. For example, the processor 401 performs the cache miss process when having read the output code 1202f shown in FIG. 14, and the process branches to the address expressed as “cache_miss_handler”. In other words, the processor 401 performs the cache miss process in a case where the data in question is not stored in a corresponding one of the cache lines in the data array 506. While performing the cache miss process, the processor 401 controls the data transfer device 405 so that the data specified at a main memory address is transferred from the main memory 406 to the local memory 403 and copied into one of the cache lines in the local memory 403 that corresponds to the line number in the main memory address of the data. After that, the processor 401 performs a process (i.e., a load process) of copying the data that has been copied in the local memory 403 into one of the registers included in the register file 408. After the load process has been completed, by using the data that has been copied into the register, the processor 401 performs an operating process according to operation instructions contained in the output program 103.

As explained above, it is possible to reduce the number of times the judgment process needs to be performed to judge whether a cache miss process should be performed, because the judgment results of the cache hit judgment processes for the plurality of memory access instructions that have a possibility of causing accesses to mutually the same cache line are combined into one judgment result. Also, it is possible to reduce the number of times the cache miss process needs to be performed, because the cache miss process is performed according to the combined judgment result. The reason is that, in a case where a cache miss process is performed according to each of the judgment results of the cache hit judgment processes performed for the plurality of memory access instructions having a possibility of causing accesses to mutually the same cache line, if a result of a cache hit judgment process for a first memory access instruction indicates that a cache miss has occurred, there is a possibility that an unnecessary cache miss process may be performed. On the other hand, with the arrangement according to the present embodiment in which the pre-loading process and the cache hit judgment process are performed in parallel, it is possible to reduce the number of times such an unnecessary cache miss process is performed. More specifically, with the arrangement in which the pre-loading process and the cache hit judgment process are performed in parallel, in a case where a result of a cache hit judgment process for the first memory access instruction indicates that a cache miss has occurred, there is a possibility that a cache hit judgment process is performed for a second memory access instruction that is performed after the first memory access instruction, before the data being the target is stored into the local memory 403 (the data array 506) in a cache miss process. In this case, there is a possibility that the judgment result for the second memory access instruction may also indicate that a cache miss has occurred. In other words, in this situation, it is necessary to perform twice the judgment process of judging whether a cache miss process should be performed. As a result, after the cache miss process is performed for the first memory access instruction, another cache miss process needs to be performed again for the second memory access instruction, although, there is actually no need to perform the cache miss process for the second memory access instruction because the data being the process target has already been stored in the local memory 403 as a result of the cache miss process for the first memory access instruction. Thus, according to the present embodiment, for the purpose of omitting such an unnecessary cache miss process, the judgment results of the cache hit judgment processes for the plurality of memory access instructions having a possibility of causing accesses to mutually the same cache line are combined into one judgment result, as explained above. As a result, it is possible to reduce the number of times the judgment process needs to be performed to judge whether a cache miss process needs to be performed. Further, it is possible to reduce the number of times the cache miss process is performed, because the cache miss processes are performed according to the combined judgment result.

As additional information, in a case where the internal representation program does not contain a plurality of memory access instructions having a possibility of causing accesses to mutually the same cache line, a cache hit judgment process for a single memory access instruction is performed. If a pre-loading process has been completed before this cache hit judgment process is completed, the processor 401 is able to access the data that has been copied into the register during the pre-loading process, immediately after the judgment result of the cache hit judgment process is determined.

In other words, according to the present embodiment, in addition to the arrangement in which the target computer 102 executes, in parallel, the pre-loading process and the cache hit judgment process that are performed with respect to each of the memory access instructions, the host computer 101 further generates the output program that allows the plurality of memory access instructions to be processed at the same time. When the target computer 102 executes the cache data controlling program as well as the generated output program, it is possible to improve the throughput related to the memory accesses in the case where the data is accessed according to the plurality of memory access instructions having a possibility of causing accesses to mutually the same cache line.

A person skilled in the art will be easily able to conceive other advantageous effects and modification examples. Thus, other modes of the present invention having a wider scope are not limited by the specific details and the exemplary embodiments of the present invention that are explained and described above. Accordingly, it is possible to modify the present invention in various manners without departing from the spirit or the scope of the general inventive concept as defined by the appended claims and the equivalents thereof.

An arrangement is acceptable in which one or both of the program conversion program executed by the host computer 101 and the cache data controlling program executed by the target computer 102 according to the embodiment described above are stored in a computer connected to a network such as the Internet and are provided as being downloaded via the network. Another arrangement is also acceptable in which one or both of the programs are provided as being set on a computer-readable recording medium such as a CD-ROM, a flexible disk (FD), a CD-R, or a Digital Versatile Disk (DVD), in a file in an installable format or in an executable format.

In the description of the exemplary embodiments above, an example is used in which the number of memory access instructions that have a possibility of using mutually the same cache line in the local memory 403 when the data is accessed is two; however, the present embodiment is not limited to this number.

Also, the correspondence relationships among the main memory addresses in the main memory 406, the cache lines in the main memory 406, and the cache lines in the local memory 403 are not limited to the example described above.

In the description of the exemplary embodiments above, the host computer 101 and the target computer 102 are configured as two separate elements; however, another arrangement is acceptable in which at least one of the host computer 101 and the target computer 102 has the functions of the other as described above.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An information processing apparatus comprising:
a program converting unit that converts a first program containing at least one instruction into a second program executable by a first information processing apparatus that includes a processor, a main memory, and a cache memory, the processor having a register operable to temporarily store data used while a program is executed, the main memory being operable to store a plurality of pieces of the data, the cache memory being divided in units of cache lines and in which at least one of the cache lines is used while the data is accessed; and
an output unit that outputs the second program, wherein the program converting unit includes:
a first instruction generating unit that generates a load cache instruction that represents an instruction to transfer to the register, stored data stored in at least one of the cache lines used while the data is accessed, with respect to a memory access instruction that is a instruction contained in the first program and represents an instruction to access to the data;
a second instruction generating unit that generates a cache hit judgment instruction that represents an instruction to judge whether the data is stored in at least one of the cache lines used while the data is accessed, with respect to the memory access instruction; and
a third instruction generating unit that generates a combine instruction instructing that judgment results obtained according to the cache hit judgment instructions generated with respect to the memory access instructions are combined into one judgment result, when the first program contains a plurality of memory access instructions having a possibility of using a mutually same cache line while the data is accessed.

2. The apparatus according to claim 1, wherein
each of the memory access instructions is a memory access instruction with a first register indirect addressing mode in which an address within the main memory of the data is calculated by adding a constant value to a value in a first register, and
the third instruction generating unit generates the combine instruction when the first program contains the plurality of memory access instructions having a mutually same value in the first register.

3. The apparatus according to claim 1, wherein
each of the memory access instructions is a memory access instruction with a second register indirect addressing mode in which an address of the data within the main memory is calculated by adding a value in a first register and a value in a second register together, and
the third instruction generating unit generates the combine instruction when the first program contains the plurality of memory access instructions having a mutually same value in at least one of the first register and the second register.

4. The apparatus according to claim 1, wherein the third instruction generating unit generates as the combine instruction an instruction to obtain a logical OR of the judgment results, when the first program contains the plurality of memory access instructions having the possibility of using mutually the same cache line while the data is accessed.

5. The apparatus according to claim 1, wherein the program converting unit further includes a fourth instruction generating unit that generates a cache miss instruction representing an instruction to transfer the data from the main memory to the cache memory by using an address in the main memory, and subsequently transfer the data from the cache memory to the register, when either the judgment results obtained according to the cache hit judgment instructions or the combined judgment result obtained according to the combine instruction indicates that the data is not stored in at least one of the cache lines.

6. The apparatus according to claim 5, wherein the program converting unit generates the second program that contains the load cache instruction, the cache hit judgment instruction, the combine instruction, and the cache miss instruction.

7. The apparatus according to claim 1, wherein the third instruction generating unit judges whether the basic block contains a plurality of memory instructions having a possibility of using mutually same cache line, for each of basic blocks obtained by dividing the first program in units of predetermined processes while the data is accessed, and generates the combine instruction when a judgment result is affirmative.

8. The apparatus according to claim 1, wherein the first program is a program written in a high-level programming language.

9. The apparatus according to claim 1, wherein the first program is a program written in a machine language that is interpretable by another processor different from the processor.

10. The apparatus according to claim 1, wherein the second program is a program written in a machine language that is interpretable by the processor.

11. The apparatus according to claim 1, wherein each of the cache lines is used in correspondence with an address within the main memory of the data.

12. An information processing apparatus comprising:
a processor having a register operable to temporarily store data used while a program is executed;
a main memory operable to store a plurality of pieces of the data;
a local memory that has a memory area operable to temporarily store the data stored in the main memory; and
a cache data controlling unit that performs a judgment process of judging whether the data is stored in the local memory, when the processor accesses the data while executing the program, and also performs, before completing the judgment process, a transfer process of transferring to the register, stored data stored in the memory area within the local memory used while the data is accessed, wherein
the cache data controlling unit performs the judgment process and the transfer process in parallel that are performed with respect to a plurality of pieces of the data.

13. The apparatus according to claim 12, further comprising a transfer unit that transfers the data stored in the main memory to the local memory, wherein
the cache data controlling unit causes the transfer unit to transfer the data from the main memory to the local memory when a result of the judgment process indicates that the data is not stored in the local memory, and subsequently performs a second transfer process of transferring the data from the local memory to the register.

14. The apparatus according to claim 12, wherein
the memory area is at least one of cache lines obtained by dividing the local memory into a plurality of sections, and
the cache data controlling unit combines results of judgment processes that are performed with respect to the plurality of pieces of the data into one judgment result, when there is a possibility that a mutually same cache line is used while a plurality of pieces of the data are accessed, and performs a second transfer process of transferring the data from the local memory to the register according to the combined judgment result.

15. An information processing apparatus comprising:
a processor having a register operable to temporarily store data used while a program is executed;
a main memory operable to store a plurality of pieces of the data;
a local memory divided in units of cache lines and in which at least one of the cache lines is used while the data is accessed;
a program converting unit that converts a first program containing at least one instruction into a second program written in a machine language that is interpretable by the processor; and
a cache data controlling unit that performs a judgment process of judging whether the data is stored in the local memory, when the processor accesses the data while executing the program, and also performs, before completing the judgment process, a transfer process of transferring to the register, stored data stored in a memory area within the local memory being used while the data is accessed, wherein
the program converting unit includes a first instruction generating unit, a second instruction generating unit, and a third instruction generating unit and generates the second program that contains at least a load cache instruction and a cache hit judgment instruction; the first instruction generating unit being operable to generate a load cache instruction that represents an instruction to transfer to the register, stored data stored in at least one of the cache lines used while the data is accessed, with respect to a memory access instruction that is a instruction contained in the first program and represents an instruction to access to the data; the second instruction generating unit being operable to generate a cache hit judgment instruction that represents an instruction to judge whether the data is stored in at least one of the cache lines used while the data is accessed, with respect to the memory access instruction; and the third instruction generating unit being operable to generate a combine instruction instructing that judgment results obtained according to the cache hit judgment instructions generated with respect to the memory access instructions are combined into one judgment result, when the first program contains a plurality of memory access instructions having a possibility of using a mutually same cache line while the data is accessed, and
the cache data controlling unit performs the judgment process and the transfer process according to the cache hit judgment instruction and the load cache instruction that are contained in the second program, when the processor is executing the second program, and further the cache data controlling unit performs the judgment process and the transfer process in parallel that are performed with respect to the plurality of pieces of the data, when the processor uses a plurality of pieces of the data.
